(19) United States
(12) Patent Application Publication
(10) Pub. No.: US 2015/0269519 A1
(43) Pub. Date: Sep. 24, 2015

(54) SYSTEM AND PROCESS FOR PROVIDING DYNAMIC FREIGHT RATE INDICES

(71) Applicant: GLOBAL MARITIME TRANSPORTATION SERVICES, INC., Shelburne, VT (US)

(72) Inventors: Edward J. Le Blanc, Charlotte, VT (US); David Ransom, Winooski, VT (US); Kristofor Wiklund, Winooski, VT (US)

(21) Appl. No.: 14/412,962

(22) PCT Filed: Jul. 1, 2013
(86) PCT No.: PCT/US13/48972

§ 371 Date: Jan. 5, 2015

Related U.S. Application Data
(60) Provisional application No. 61/668,341, filed on Jul. 5, 2012.

(51) Int. Cl. G06Q 10/08; G06F 17/30

(52) U.S. Cl. CPC G06Q 10/0838; G06F 17/30867

(57) ABSTRACT

A process and system for gathering and presenting confidential contract and publically filed tariff line item rates and surcharge data. Confidential contract information and public tariff information regarding individual shipments are received and saved in a database. The information is saved such that the details of each shipment are searchable. A request from a user is received at the database, wherein the request seeks rate information pertaining to shipping at least one of a specific commodity, a specific route, and using specific equipment. In response to the receipt of the request, the database is searched for records with applicable information. The located information can then be presented to the requesting user in aggregate form including the rates for a predefined time period up to the present time, whereby a requesting user can determine actual rates and trends for the rates for the predefined period.

### BACKGROUND OF THE INVENTION

1. Field of the Invention

The present invention relates to a system and method for gathering and presenting confidential contract and publically filed tariff line item rates and surcharge data for particular use in the shipping industry.

2. Description of the Related Art

There are several published containerized freight rate indices available such as the China Containerized Freight Index (CCFI), the Drewry Freight Insight Index, the Shanghai Containerized Freight Index (SCFI), and the Container Trade Statistics Index (CTS Index), the Transpacific Stabilization Agreement Index (TSA Index), and the Drewry-Cleartrade World Container Index (WCI). These known indices are developed from information provided in aggregate form by the contributors to the index publishers. Each of these indices is published periodically and is thus static for each publishing period. In addition, the indices are not flexible in that the data cannot be parsed to provide specific reports because the raw information is collected by the index publisher in aggregate form. Furthermore, each of the indices is specific to a particular shipping route or routes.

### SUMMARY OF THE INVENTION

An object of the present invention is to provide a system and process for providing a searchable database of confidential contract and public tariff information that allow parties to shipping contracts to manage their contracts and simultaneously render a dynamic searchable database for current freight rates.

The present invention allows each party, i.e., shippers, shipper associations, carriers, and carrier conferences, to determine the benefits of the cargo prior to accepting a booking to ensure they are maximizing profit and providing employees with a beneficial tool to assist in increasing productivity.

According to one embodiment of the present invention, a process for gathering and presenting confidential contract and publically filed tariff line item rates includes receiving confidential contract information and public tariff information regarding individual shipments and storing the information pertaining to individual shipments as respective records in a database on a server. The information is stored such that details of each shipment are searchable. In this step, tariff line items, rule surcharges and other common tariff elements, as well as confidential contract rates and rules that affect the line items are entered into a browser-based public filing system. All rates are given a bottom line calculation, and the total amounts as well as any additional charges are recorded.

After the database is populated with records, the system receives a request from a requesting user for rate information matching specific criteria, i.e., pertaining to shipping at least one of a specific commodity, a specific route, and/or using specific equipment. The request is made using, for example, an Application Programming Interface (API) using Representational State Transfer (REST) architecture.

If the request is invalid, a message is returned to the user indicating the error.

If the request is valid, the database is queried for records with applicable information and the data is parsed for the pertinent data and presented to the requesting user in aggregate form. The applicable information returned to the user includes rates for a predefined time period, whereby a requesting user can determine actual rates and trends for the rates for the predefined period. The information is preferably returned using XML or JSON formatting, however, other formatting options can be readily envisioned. The user can then use the data to construct a dynamic visual representation using charting software such as, for example, HIGHCHART™.

### Pre-Client Request

Before a user accesses the system with the intention of retrieving a set of data, tariff and service contract rate information must be entered into the database via, for example, a web-based public filing system. Although the web-based public filing system is used in the preferred embodiment, any filing system known or hereafter developed may be used to populate the database with tariff and service contract rate information. This information is routinely updated and maintained to reflect current shipping rates.

A background task running periodically on the server performs and records a bottom-line calculation on all active rates on the system which is subsequently cached for reuse. This bottom line calculation is a basic rate calculation based on default values for a container and tariff, as well as default settings for any applicable rule surcharges. When the task encounters a new tariff, a thread is spawned and all rates in that document are assigned a bottom line calculation. These calculations are performed chronologically starting with the rate's effective date, and again for each instance where an item is changed that could affect the total amount of the bottom-line calculation. Such events that could change a rate include but are not limited to: new tariff amendments to the parent or governing tariffs, amendments to the service contract (if the rate is defined under a service contract), new rule filings or amendments to current rules, new inland table filings or amendments to current inland tables, new amendments to the commodity associated with the given rate, or new amendments to the rate itself.

After the initial thread performs its calculations, the background task will monitor the tariff to see if any of the events took place since the last time the task was run. If the task finds an event, the task performs and records a new calculation for all affected rates.

### Client Request

The user enters criteria to filter the resulting chart, thereby customizing the displays of data on a client web page. This specific carriers, locations, commodities, surcharge names (if applicable), and any other items related to the shipment, including equipment size, type, temperature, etc. These criteria can be entered in two ways: First, the user can manually enter the information in the provided form objects; and second, the user can choose from a pre-existing set of criteria that has been saved. There are filter sets that include pre-defined search criteria, or the user can save any previous searches for future use. Any of these methods populates the request form elements with the necessary information to build a request.

The user then submits the form and turns the control over to the client page. The client packages this information into a formatted request such as a properly formatted XML request object, and sends it to the server.

The server receives the request, and does some basic error checking at this stage. If the request is found to be invalid, an error message is generated and sent back to the client for connection, after which it is re-submitted. If the request is valid, the server retrieves all the applicable rates from the database using the filters defined in the request. If no rates are found, an error message is sent to the client informing it that the request set is empty. Otherwise, these rates are aggregated to produce daily data points over a period of time. The server then packages these data points in a response object, formatted in the way requested by the client page (usually XML or JSON), and sends it back to the client.

The client accepts this response, and builds a visual representation most appropriate to the data set. This is usually a line or area chart, with the x-axis representing time, but it could also be a table, pie, or bar chart, depending on the data and the user preference. The system currently uses open source, java-script based charting software to build the graphic user interface results directly on the web page, which is then displayed to the user.

At this stage, all the information regarding the filters is saved on the page, and the user can modify it if the returned data is not what the user sought to obtain. A subsequent request can then be made for another data set.

### BRIEF DESCRIPTION OF THE DRAWINGS

FIG. 1 is a schematic system diagram according to an embodiment of the present invention;

FIG. 2 is a flow chart showing the process according to an embodiment of the present invention;

FIG. 3 is a chart showing east coast export rates as an aggregate from the United States for a one year period according to an embodiment of the present invention;

FIG. 4 is a chart showing an example of surcharge rates in the tariff or contract rule according to an embodiment of the present invention;

FIG. 5 is a Ticker Market scroll showing commodity prices according to an embodiment of the present invention;

FIG. 6 is a chart comparing one vessel operating common carrier versus another according to an embodiment of the present invention; and

FIG. 7 is a chart showing a bottom line calculation versus a base ocean freight according to an embodiment of the present invention.

### DETAILED DESCRIPTION OF THE PRESENTLY PREFERRED EMBODIMENTS

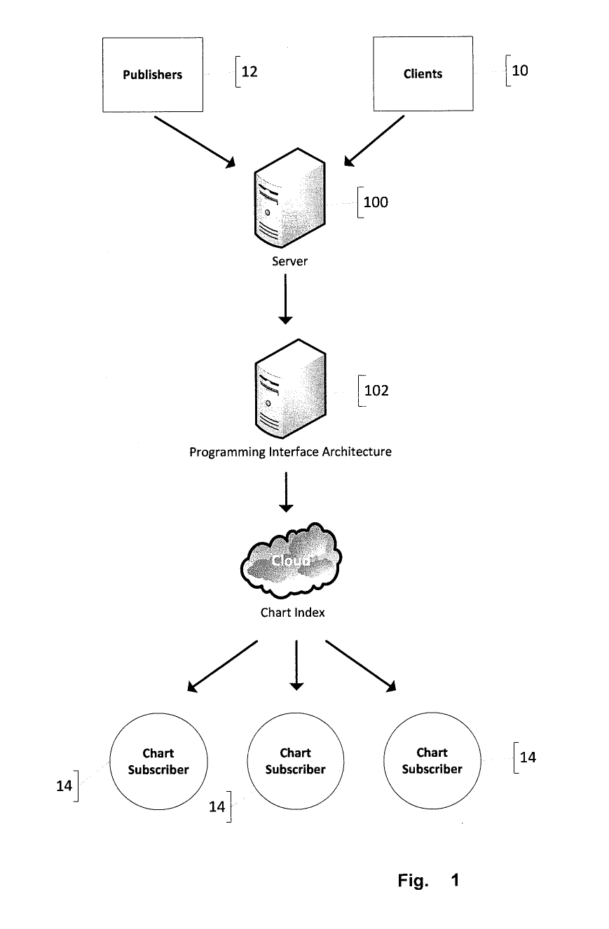

According to FIG. 1, a system according to a preferred embodiment of the present invention includes a server 100 including a memory with a database storing public tariff and confidential service contract rates information for shipments made by common carriers. The tariff and confidential service contract information is entered directly by one of the parties to the contract 10 or indirectly by publishers or other representatives 12. The parties to the contract may include, but are not limited to, shippers, shipper associations, carriers, and carrier conferences. The owner of the server 100 and database may be a publisher 12.

The system also includes an application programming interface (API), namely programming interface architecture 102 for receiving requests from requesting chart subscriber users 14 and querying the database in the server 100 for the requested information. The requesting users 14 may, for example, comprise shippers who wish to ship commodities, shipper associations, carriers and/or carrier conferences, who wish to monitor currents shipping rates. Although shown as separate equipment, the server 100 and API 102 may be a single component. The server 100 and/or API 102 may be a single server or a data center facility having a plurality of servers.

The server 100 provides a database allowing contracting parties to manage information related to their individual shipments. Thus, the storage provides a repository for the particular information regarding all of the party's public tariffs and confidential contracts. For each shipment, the information saved includes at least commodity; origin; destination; volume; duration; and rates. As explained above, the rates may be public tariff rates or confidential contract rates. The same database is used by users to query current shipping rates for specific commodities, routes, and/or shipping equipment. The rates of individual shipments by confidential contracts are not available to users 14. In other words, a requesting user will not be able to determine a rate that a particular carrier charged for a particular shipment if the shipment was based on a confidential contract. However, the rates will be available in aggregate form. For example, if a requesting user 14 wishes to know the current rates for shipping refrigerators from China to the United States, the user can search by commodities, origin and destination and determine the current rate for this type of shipment from China to the United States. The API 102 will query the database and provide the information in aggregate form. Similarly, a requesting user can request rates that are being charged for specific equipment. For example, different rates may apply to 20′ containers, 40′ containers, and refrigerated containers, i.e., “reefers”.

Moreover, contract rates and tariff rates include base ocean freight (BOF) rates and additional surcharges such as bunker surcharges, terminal charges, documentation fees, and other rule specific charges. That is, the contract rates or tariff rates include all possible charges on shipping rates. A background task runs on the storage unit to perform a bottom line calculation on rates in the system. The bottom line calculation is based on the base ocean freight (BOF) rates and the surcharge levels. Thus, the background task allows users 14 to be presented with information indicating surcharge elements and note fluctuations.

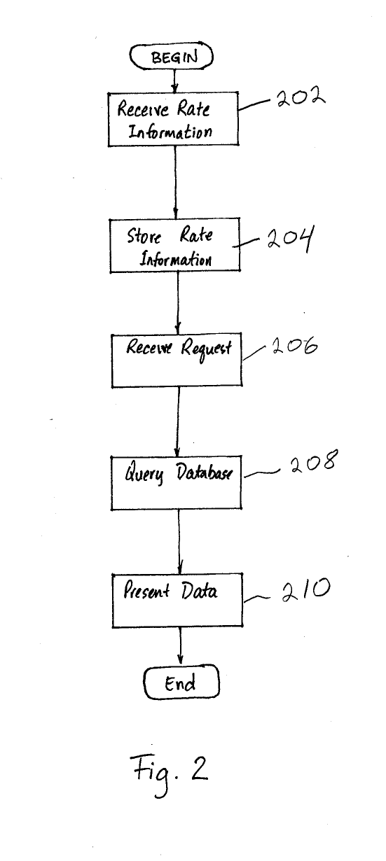

The process for gathering and presenting confidential contract and publically filed tariff line item rates and surcharge data will now be described with reference to FIG. 2. According to the process of the present invention, confidential contract information and public tariff information regarding individual shipments is received from contributors 10 and/or their publishers or representatives 12, step 202. The information pertaining to each individual shipment is stored as a record in a database in server 100, wherein the information is saved such that the details of each shipment are searchable, step 204.

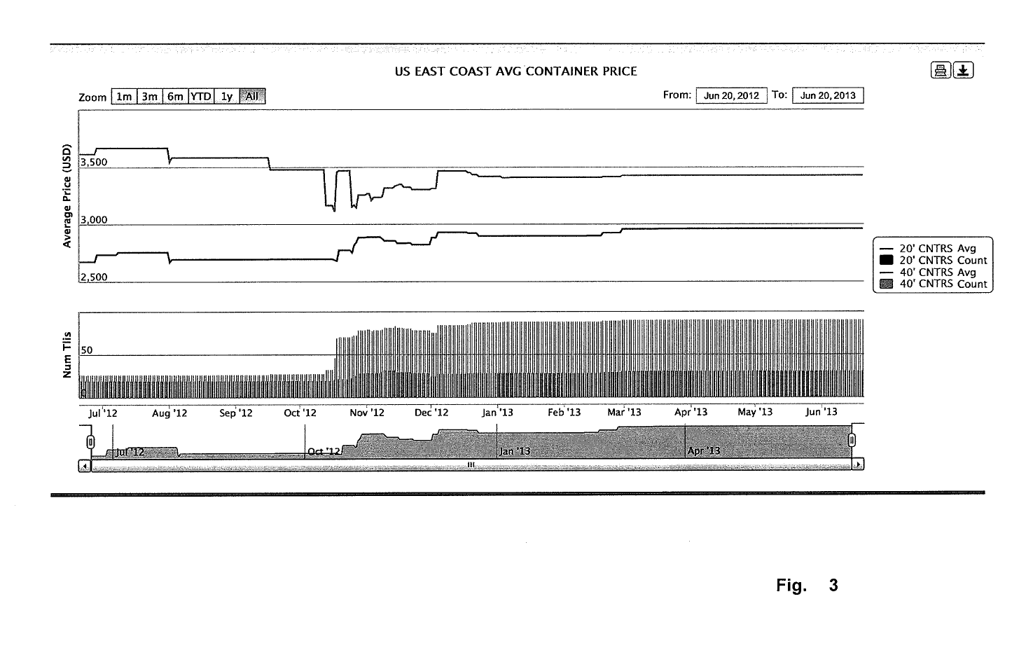

A request from a requesting user is received by the API 102 for rate information pertaining to shipping at least one of a specific commodity, a specific route, and using specific equipment, step 206. The API 102 then queries the database in the storage unit 100 for records with applicable information (step 208) and presents to the requesting user in aggregate form the rates for a predefined time period up to the present time, step 210. The predefined time may, for example, be user selectable and continuously adjustable up to a maximum limit. For example, the API may present to the requesting user all applicable rate information for the week prior to the request. The information is preferable presented in the form of a chart using a charting program or application such as, for example, HIGHCHARTS™ so that a requesting user can easily determine actual rates and trends for the rates for the predefined period. FIGS. 3-7 are example of the data that can be output to users.

FIG. 3 shows east coast export rates as an aggregate from the United States for a one year period. The information could alternatively be shown for any period selected by the user including, but not limited to, periods of one month, three months, or six months.

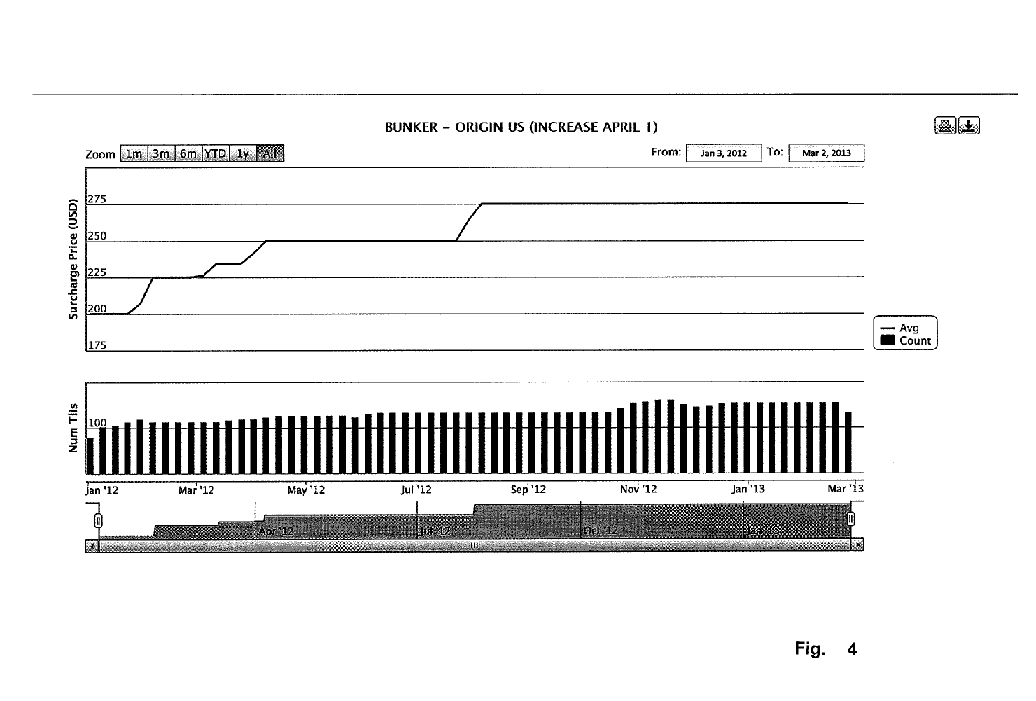

FIG. 4 is an example of a chart showing surcharge rates in the tariff or contract rule such as, for example, a bunker surcharge. Here a user can determine volatility or trends of a specific surcharge rate.

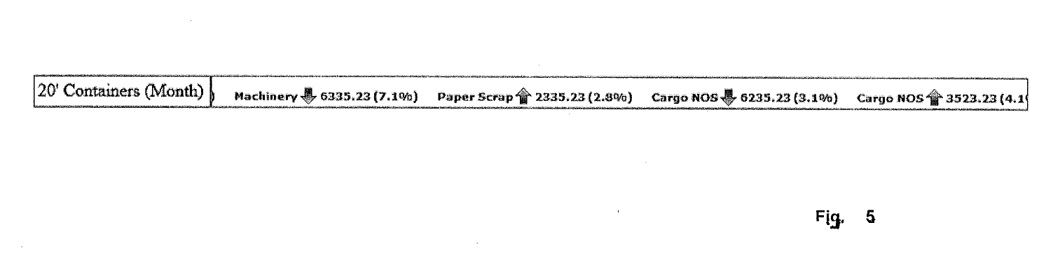

FIG. 5 shows another example in which commodity prices are depicted in a Ticker Market scroll and indicates whether the rates are moving upward or downward based on the new filings.

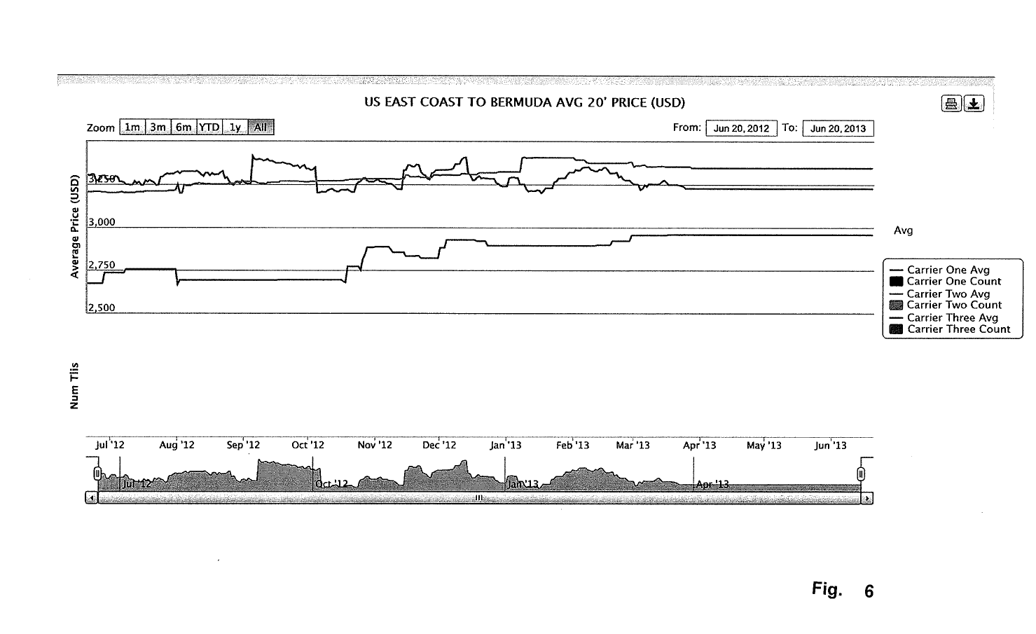

FIG. 6 shows an example of a chart comparing one vessel operating common carrier (VOCC) versus another.

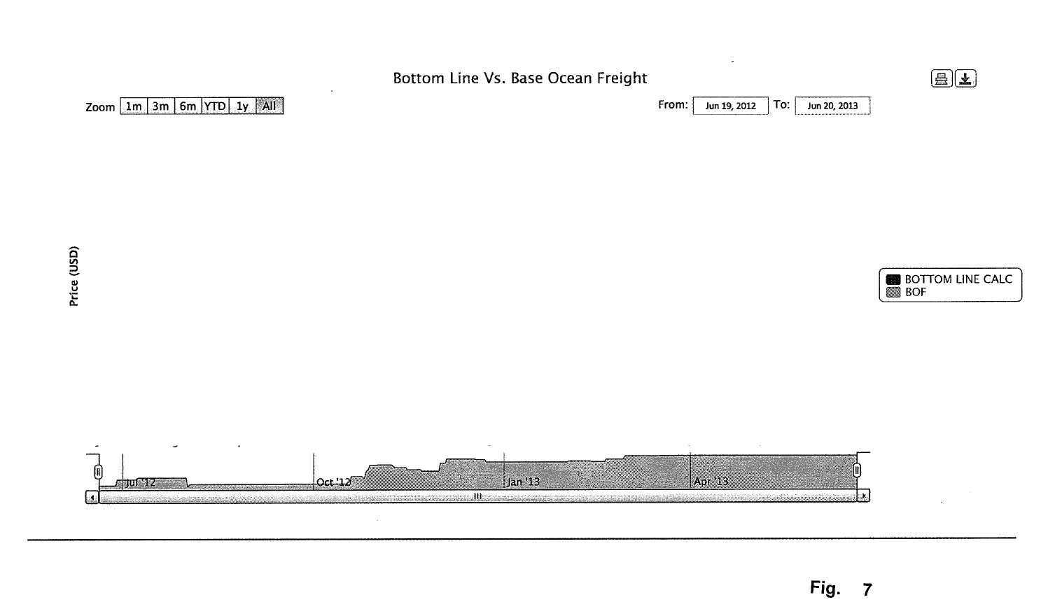

FIG. 7 is an example of a chart showing a bottom line calculation versus a base ocean freight (BOF).

1. A process for gathering and presenting to request a user confidential contract and publically filed tariff line item rates and surcharge data, said process comprising:
receiving confidential contract information and public tariff information regarding individual shipments and storing the information pertaining to each individual shipment as a record in a database, wherein the information is saved such that the details of each shipment are searchable;
receiving a request from the requesting user for rate information pertaining to shipping at least one of a specific commodity, a specific route, and using specific equipment; and
searching the database for records with applicable information to present in response to the request and in aggregate form, the rates for a predefined time period up to the present time, whereby the requesting user can determine actual rates and trends for the rates for the predefined period.

2. The process of claim 1, wherein access to the confidential contract information is restricted to one or more authorized parties.

3. The process of claim 2, wherein said one or more authorized parries comprises one or more common shipping carrier that provided the confidential contact information.

4. The process of claim 1, wherein the rates are presented in a format showing the base ocean freight rates and other applicable surcharges.

5. A system for gathering and presenting to a requesting user confidential contract and publically filed tariff line item rates and surcharge data, said system comprising:
a data having stored data comprising confidential contract information and public tariff information regarding individual shipments, wherein the data is stored such that details of each shipment are searchable;
means for receiving a request receiving a request from a requesting user for rate information pertaining to shipping at least one of a specific commodity, a specific route, and using specific equipment; and
means for searching the database for records with applicable information to present in response to the request and in aggregate form, the rates for a predefined time period up to the present time, whereby a requesting user can determine actual rates and trends for the rates for the predefined period.

6. The system of claim 5, wherein access to the confidential contract information is restricted to one or more authorized parties.

7. The system of claim 6, wherein said one or more authorized parries comprises one or more common shipping carrier that provided the confidential contact information.

8. The system of claim 5, wherein the rates are presented in a format showing the base ocean freight rates and other applicable surcharges.
